(19) United States
(12) Patent Application Publication
(10) Pub. No.: US 2009/0250440 A1
(43) Pub. Date: Oct. 8, 2009

(54) OUT-OF-PHASE ELECTRICAL WELDER AND PROCESS

(76) Inventors: Tze-Yee Ryan YAP, Laveen, AZ (US); Chi Sang Li, Kowloon (CN); Kelvin Koon Wan Yao, Kendal Park, NJ (US); Hoon Yeng Yap, Tempe, AZ (US)

Correspondence Address: DORSEY & WHITNEY LLP;INTELLECTUAL PROPERTY DEPARTMENT, 250 PARK AVENUE, NEW YORK, NY, 10177, US

(21) Appl. No.: 12/098,205

(22) Filed: Apr. 4, 2008

(51) Int. Cl. B23K 11/24; H05B 1/02; H05B 3/02

(52) U.S. Cl. 219/110; 219/108; 219/497

(57) ABSTRACT

Electrical welding process and device using intersecting, electrically contacting welding elements are disclosed. The intersecting welding elements are powered out of phase from each other, such that there is no short circuiting around the welding elements being heated and no electrical insulation is needed between intersecting welding elements. Current directors can be used to alternatingly direct the current through the intersecting welding elements. The process and device can be used to weld various workpieces, including thermoplastic binders and folders.

### FIELD OF INVENTION

The invention relates generally to welders, and more particularly to welders configured to weld along a predetermined pattern.

### BACKGROUND OF THE INVENTION

In electrical welding machines, welding elements, such as electrodes or heating elements (e.g., electrically heated resistance wires or coils), are used to transfer heat to workpieces to be joined. For example, pulse heat welding, which is commonly used to weld polypropylene (PP), welds by passing pulses or bursts of electrical energy through the heating elements, such as nickel-chromium resistance wires, such that the heating elements transfer heat at a very high temperature for short periods of time.

For welding along a predetermined pattern, heating elements are arranged in the corresponding pattern. When heating elements are arranged in an intersecting or overlapping pattern, however, the electrical contact of intersecting heating elements can short circuit the heating elements, which can stop the welding, at least in certain parts of the welding device, or cause the current level to increase, often to the ignition point of the workpieces, which can cause a fire or other dangerous conditions and damage equipment.

To prevent short circuiting, intersecting heating elements are electrically insulated from one another. For example, U.S. Pat. No. 5,451,286 discloses providing insulation of intersecting pulse-heat wires with electrically insulating and heat-conducting layers and strips of polytetrafluoroethylene (PTFE) such as TEFLON® tape, manufactured by 3M, or polyimide such as KAPTON®, manufactured by DuPont. It is difficult, however, to provide insulation that is thin enough not to increase the height of the intersection and strong enough to withstand the high frequency and high pressure of the pulse heat welding production cycle. Other disadvantages of using insulation includes uneven welds due to the thickness of the insulating material in between intersecting heating elements or slimming of the insulating material, complex and expensive equipment tooling, complex temperature control, limited sources for insulting materials, and increased manufacturing costs due to the expense for insulating materials equipment setup. Further, when the insulting material is be broken or worn out, a short circuit can develop.

Alternatively, individual intersecting heating elements can be fired separately, in multiple steps, with electrical current to each heating element being supplied by a separate supply circuit. This process, however, results in a prolonged welding time.

Thus, there is a need for an improved welding process that provides a simplified welder design and operation while avoiding short circuit.

### SUMMARY OF THE INVENTION

In an embodiment, the invention relates to a method for electrically welding two workpieces. The method comprises: placing a first and second welding elements (e.g., heating elements such as metal wires or coils) in association with first and second portions of the workpieces, respectively, for heating and welding the workpieces; and powering the first and second welding elements out of phase from a common power source. The welding elements can be powered out of phase by alternatingly directing a current through each of the first and second welding elements for causing the first and second welding elements to weld the workpieces substantially simultaneously.

The current can be alternatingly directed through the first and second welding elements by applying a potential difference alternatingly across ends of the first welding element and ends of the second welding element, and/or by providing a source current that has a waveform and cyclically directing first and second portions of the waveform through the first and second welding elements, respectively. For example, an alternating current can be provided as the source current, and positive and negative portions of that waveform can be directed through the first and second welding elements, respectively. Current directors, such as diodes, can be used to alternatingly direct the waveform portions through the welding elements.

In a further embodiment, a power factor of the waveform directed through the welding elements is controlled with a power factor controller that is connected between the power source and the current director. The power factor controller can comprise a phase controller, e.g., a triode or two silicon-controlled rectifiers joined in an inverse parallel configuration, that is configured for conducting a fraction of the waveform portions.

The present method can be used to weld workpieces made of any suitable material, including thermoplastic, such as polypropylene. In an embodiment, the method is used to weld thermoplastic sheets to make a folder or binder cover.

The invention also relates to an electrical welder comprising first and second welding elements, a power source connected to the welding elements, and an electrical circuit configured to conduct a current out of phase from the power source to the first and second welding elements.

### BRIEF DESCRIPTION OF THE DRAWINGS

The invention will be better understood with reference to the attached drawings illustrating preferred embodiments, wherein:

FIG. 1 is a perspective view of a pulse heat welder constructed according to an embodiment of the invention;

FIG. 2 is a perspective view of a welding member thereof;

FIG. 3 is a schematic diagram of a welding circuit arranged according to an embodiment of the invention;

FIG. 4 is a schematic circuit diagram of a welding circuit of another embodiment of the invention;

FIGS. 5A-5D are illustrations of waveforms produced in the welding circuit according to embodiments;

FIGS. 6-7 are schematic circuit diagrams of welding circuits of other embodiments of the invention;

FIG. 8 is a perspective view of a cover of a ring binder made according to an embodiment of the invention; and

FIG. 9 is a perspective view of a 3-ring binder made according to the embodiment.

### DETAILED DESCRIPTION OF THE PREFERRED EMBODIMENTS

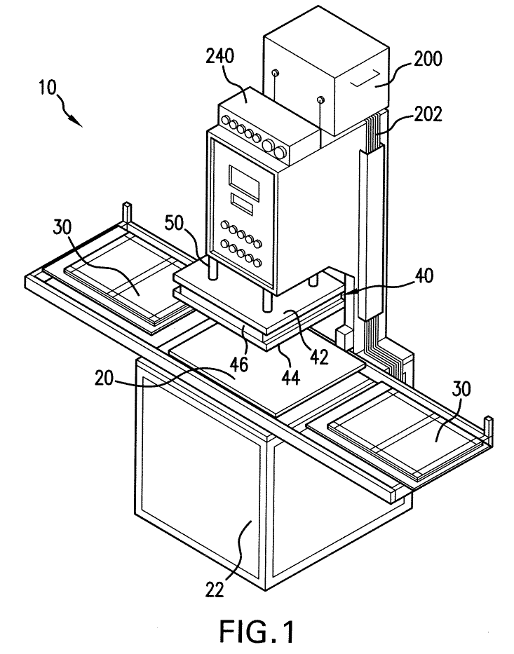

The embodiment of FIG. 1 is an electrical-pulse heat welder 10, preferably for welding plastic materials. The welder 10 is exemplary, and other suitable pulse heat welders, other types of welders, or welder components can be used.

The welder 10 includes a platform 20 supported on a support 22. For making binders, the platform 20 is preferably substantially planar and is configured to receive thereon a welding member 30 that is configured to provide heating to weld the workpieces. The welder 10 also includes a pressure member 40, which is movably mounted on the welder 10 and is configured to operably engage with and exert a sufficient pressure on the welding member 30 during welding operations. In preferred embodiments, the welding member 30 and pressure member 40 are molds configured to cooperatively weld a predetermined pattern. Preferably, the welding member 30 and pressure member 40 are upper and lower molds configured to cooperatively weld a predetermined pattern.

One or multiple welding members 30 can be mounted on the platform 20. The welding member 30 is preferably movably mounted on the platform 20. For example, when multiple welding members 30 are mounted on the platform 20, the welding members 30 can be configured to alternately slide under the pressure member 40. In the embodiment shown in FIG. 1, two welding members 30 are mounted on either side of the welding station 20. In operation, the welding members 30 are alternately loaded and laterally slid under the pressure member 40, then slid back therefrom and unloaded and reloaded with the workpieces to be welded.

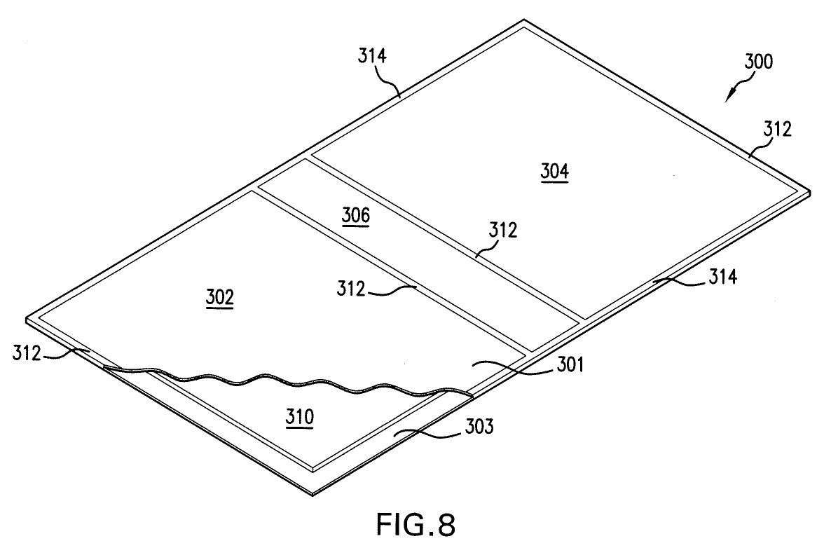

To make a cover of a ring binder 300 as shown in FIG. 8, the welding member 30 is loaded with two sheets of plastic material 301,303, e.g., thermoplastic material such as polypropylene. Reinforcements 310, such as paper cardboards or other stock material, are placed between the sheets 301,303 so the sheets 301,303 are welded around the reinforcements 310 to define binder panels 302,304,306. The reinforcements 310 are used for structure and rigidity. The reinforcements 310 preferably have substantially the same size as the areas defined by the welds, i.e., the panels 302,304,306. The loaded welding member 30 is then slid under the pressure member 40, and the pressure member 40 is moved downward to exert sufficient pressure on the assembled workpieces. As described below, the sheets 301,303 are heated and fused along the pattern 312,314 under pressure, and the welded sheets 301,303 are then cooled to re-solidify. The sheets 301,303 can be cooled passively, i.e., by discontinuing the heating, or with a cooling medium, e.g., air, water, coolant, or any other suitable medium having a temperature lower than the heating temperature. Pressure is then released by moving the pressure member 40 upward, away from the welding member 30.

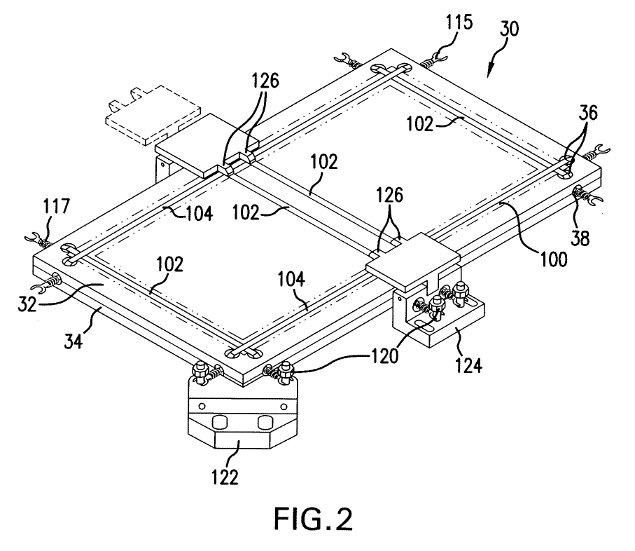

The welding member 30 of this embodiment can be made of any suitable electrically non-conductive, heat-resistant material that can withstand the high temperatures of pulse heat welding, e.g., thermoset plastic, metal, and ceramic. Preferably, the welding member 30 comprises a mold made of a thermoset plastic, such as a thermoset phenolic resin, e.g., Bakelite. The welding member 30 can include a single layer or multiple layers of such thermoset material, and preferably includes at least two layers 32,34 of thermoset phenolic resin as shown in FIG. 2, which can be laminated or otherwise attached together. The welding member 30 can have any suitable and desired dimension and configuration, but preferably is configured and sufficiently sized to receive thereon workpieces being welded. For example, for welding typical ring binders or folders, the welding member 30 can be substantially planar and generally rectangular, and has dimensions at least as large as, and preferably greater than, the workpieces. The welding member 30 is also configured and sufficiently sized to receive heating elements therein. In a preferred embodiment, the welding member 30 can have a thickness of at least about ¼ inches, but other dimensions can be used in other embodiments.

The pressure member 40 is preferably made of a non-corrosive or corrosion-resistant metal having thermal conductivity sufficient to transfer heat therethrough. Preferred examples of such suitable metals include copper alloys, brass, bronze, aluminum alloys, and stainless steel. For welding plastic, the pressure member 40 can be heated to keep the plastic workpiece from sticking thereto. For example, the pressure member 40 can be heated to about 60° C. to 140° C. Alternatively, the pressure member 40 can be coated with a non-stick material (e.g., PTFE such as TEFLON®).

The pressure member 40 can be configured as desired and suitable, depending on the welding configuration and the configuration of the welding member 30. For welding a typical ring binder or folder, the pressure member 40 can be a mold including a substantially flat steel base plate of a square or rectangular shape. The mold can include relatively thin walls or protrusions around the edges of the plate.

In a preferred embodiment, the pressure member 40 comprises first and second parts 42,44 that are spaced apart from each other. The first and second parts 42,44 are preferably made of material having thermal conductivity, preferably non-corrosive metal having sufficient thermal conductivity to transfer heat therethrough. Preferably, a filler 46, which is preferably a compressible material, at least partially fills the space between the first and second parts 42,44, to expulse excess air trapped between the first and second parts 42,44. The filler 46 preferably entirely fills the space between the first and second parts 42,44. The filler 46 is preferably a relatively soft foam material, e.g., soft rubber foam, that can withstand heat of at least up to about 140° C.

The surface of the pressure member 40 that contacts the thermoplastic material to be welded during operation can include embossed or textured patterns as desired, to provide embossment or patterns on the welded portions of the thermoplastic material. Also, the embossing or patterns can be at least partially covered with a thin heat-resistant tape or film (e.g., PTFE such as TEFLON®) to soften the effect of embossing and to provide a smoother, more even texture to the thermoplastic material.

The pressure member 40 is preferably mounted to the welder 10 so that it can be vertically moved, e.g., pneumatically. For example, the pressure member 40 can be attached to the welder 10 by mounting members 50, such as slide rails or pneumatic cylinders. In preferred embodiments, the pressure member 40 is configured to exert a pressure of at least about 20 psi, preferably at least about 25 psi, and at most about 60 psi, preferably at most about 45 psi on the welding member 30 that is placed thereunder. It will be appreciated, however, that the pressure exerted by the pressure member 40 can be varied depending on the size of the pneumatic cylinder and welding areas of the welder 10.

The welding member 30 includes first and second welding elements 102,104. In a preferred embodiment, the first and second welding elements 102,104 each comprise a plurality of first and second welding elements. The welding elements 102,104 are preferably heating elements that conduct an electrical current from one end to another. The welding elements 102,104 are made of conductive material, such as metal wires or coils that generate heat when a current is passed therethrough. In a preferred embodiment, nickel-chromium resistance wires are used. Such wires can transfer very high-temperature heat in a short period of time, and therefore are suitable for various electrical welding, including pulse heat welding. The welding elements 102,104 preferably include end portions 115 configured to be retained with a retention member, such as a fastener. Each welding element 102,104 also preferably includes a stretcher, such as a spring 117, proximate each end portion 115 to maintain the welding element 102,104 straight during the thermal expansion and contraction during welding cycles. The first welding elements 102 are sufficiently long to extend at least the length 35 of the welding member 30. Similarly, the second welding elements 104 are sufficiently long to extend at least the width 33 of the welding member 30. Preferably, the welding elements 102,104 are at least about 1 inch longer than the respective length 35 or width 33 of the welding member 30. The thickness of the welding elements 102,104 are preferably uniform and can be selected as suitable. In an example, the thickness is about 0.1 mm to 0.5 mm, but other dimensions can be used in other embodiments.

The welding elements 102,104 are arranged to correspond to the welding pattern of the welded product. For example, the first and second welding elements 102,104 can respectively be connected in parallel with each other as shown in FIG. 2 to produce a welded binder cover 300 shown in FIG. 7. In this example, the two outer first welding elements 102 and second welding elements 104 respectively form vertical and horizontal weld seams 312,314 that extend along the outer edges of the binder 300, while the two inner first welding elements 102 form inner vertical weld seams 312 that define panel 306 therebetween. Each second welding element 104 crosses and intersects with, and electrically contacts, each of the first welding elements 102 at the ends thereof. Other embodiments can use welding elements of different configurations or in different arrangements to form the desired welding pattern. Preferably, however, at least one first welding elements 102 at least partially intersects or overlaps with, and is electrically connected to, at least one second welding element 104.

The welding elements 102,104 are provided on the welding member 30 in any desired pattern. For example, the welding elements 102,104 can simply be laid in a desired pattern on a surface of the welding member 30 and secured to the welding member 30 or to external retention members, adhesively (e.g., with tape strips), with fasteners, or by any other suitable means. In a preferred embodiment, holes 36,38 are provided on the top and side surfaces of the welding member 30 to extend the end portions 115 of the welding elements 102,104 therethrough and secure them to external retention members 122,124, such as clamps. The end portions 115 of each welding element 102,104 are preferably inserted into the top holes 36 of the welding member 30, pulled out through the side holes 38, and secured to retention members 122,124 with fasteners 120, such as screws and nuts. For clarity, only one of the corner retention members 122 is shown in FIG. 2. In other embodiments, other suitable retention arrangement can be used. The retention member 124 engaging the inner vertical welding elements 102 can also include an alignment member 126, such as an alignment jig, for aligning the welding elements 102. The alignment member 126 can be movable, e.g., movable at a hinge as shown in FIG. 2, to facilitate engagement/disengagement of the alignment member 126 with the welding elements 102,104.

In a preferred embodiment, portions of the welding member 30 immediately below the welding elements 102,104 can be removed to form channels 100 that substantially correspond to the shape of the welding elements 102,104, so that the welding elements 102,104 are substantially flush with the welding member 30. A barrier layer having a higher heat resistance than the welding member 30, e.g., ceramic, can be provided between the welding member 30 and the welding elements 102,104 to protect the welding member 30 from the high temperatures of electrical welding. For example, barrier layers in the form of ceramic stripes can be placed in the channels 100. The barrier layers can be configured to partially or entirely replace the welding member material that is removed to form the channels 100. The barrier layers can be attached to the welding member 30 in any suitable manner, such as with an adhesive. In addition to or alternative to the barrier layers, a layer of heat-resistant, non-conducting material, such as PTFE or polyimide tapes or sheets (e.g., TEFLON® or KAPTON® tapes or sheets), used on top of heat-conductive metal elements/strips/inserts, can optionally be provided under the welding elements 102,104, to form a heat sink for excess heat generated during welding cycles. No electrical insulation is needed, however, between intersecting welding elements, i.e., between horizontal welding elements 104 and vertical welding elements 102.

Referring to FIGS. 1, 3-4, and 6-7, the welding elements 102,104 are connected to a power source 200 via conduits 202, e.g., at the end portions 115. The power source 200 provides a source current to the welding elements 102,104, to cause the welding elements 102,104 to heat and melt the workpieces placed on the welding member 30. The power source 200 can be any suitable power source typically used in electrical welding, and preferably is a stable voltage power source of a voltage selected to cause the welding elements 102,104 to reach the desired temperatures in the desired time to weld the workpieces. Preferably, the power source 200 provides alternating current (AC). The alternating current can have a traditional sinusoidal waveform or another suitable waveform. Any suitable voltage can be used. In preferred embodiments, the voltage supplied by the power source 200 is between about 50 and 500 VAC, more preferably between about 100 and 420 VAC. Preferably, the welding elements 102,104 are removably connected to the conduit 202, so that the welding elements 102,104 can be connected and disconnected from the power source 200 as desired, for example when using multiple welding members 30.

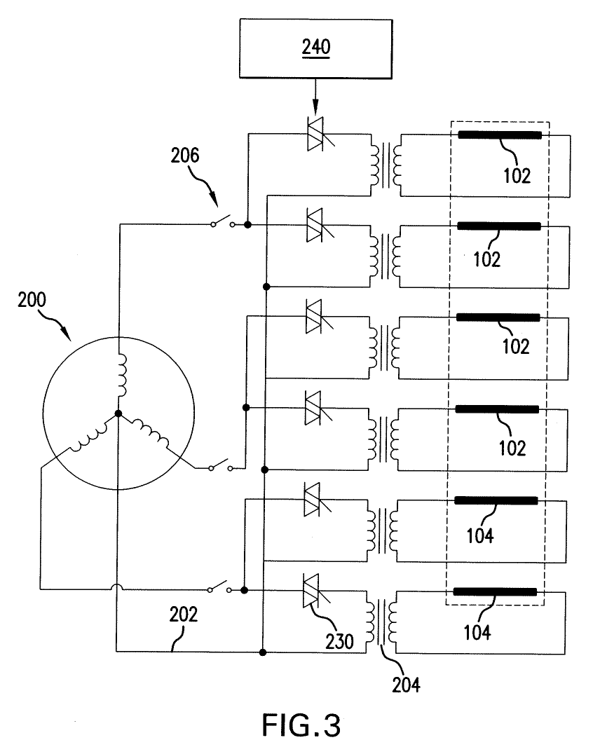

The first and second welding elements 102,104 are powered out of phase from each other, preferably from a common power supply. In the embodiment shown in FIG. 3, the power source 200 is a 3-phase AC power supply, but other power supply, such as a 2-phase AC power supply, can be used in other embodiments. A person having ordinary skill in the art would appreciate how to provide a circuit that enables the use of a different power supply that provides the desired power signal to each of the welding elements 102,104. A transformer 204 is connected between the power source 200 and each welding element 102,104. The transformers 204 separate the current conducted to the welding elements 102,104, such that the voltage conducted from the transformers through the welding elements 102,104 is floating voltage. Thus, the first and second welding elements 102,104 are powered simultaneously, with the same voltage, but out of phase from the other. This reduces the risk of short circuiting between the first and second welding elements 102,104, even though the first and second welding elements 102,104 are in electrical contact, such that it is not necessary to electrically insulate the first and second welding elements 102,104 from each other.

In an embodiment, the first welding elements 102 and second welding elements 104 are powered by alternatingly directing a current through each of the first and second welding elements 102,104 for causing the first and second welding elements 102,104 to weld the workpieces substantially simultaneously. The current can be alternatingly directed by applying a potential difference alternatingly across the ends of the first welding elements 102 and the ends of the second welding elements 104, and/or by cyclically directing a first portion of the waveform of the source current through the first welding elements 102 and a second portion of the waveform of the source current through the second welding elements 104. When portions of the source current waveform are conducted through the first and second welding elements 102,104, the voltage conducted through the welding elements 102,104 corresponds to that of the conducted waveform portions. For example, when first and second half portions of the source current waveform are conducted through the first and second welding elements 102,104, the voltage conducted therethrough is about half the voltage of the source current.

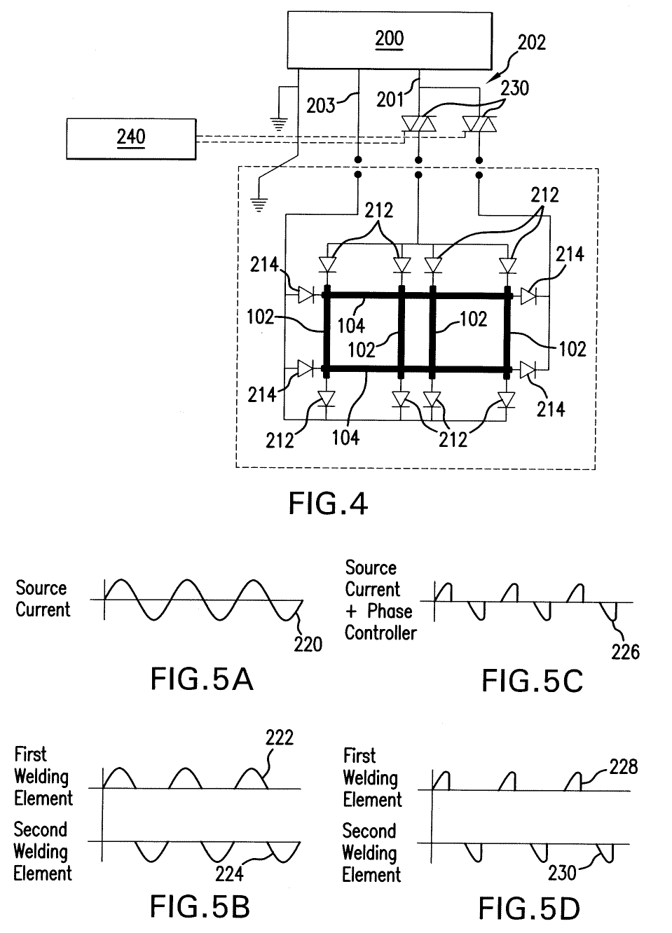

In the embodiment shown in FIG. 4, each first welding element 102 is connected to a first current director 212 at an end thereof, and each second welding element 104 is connected to a second current director 214 at an end thereof. The current directors 212,214 are capable of selectively conducting a current in a predetermined direction. The current directors 212,214 alternatingly direct the current through the first and second welding elements 102,104 by applying a potential difference alternatingly across the ends thereof. Optionally, another first or second current director 212,214 can be connected to the other end portion of each welding element 102,104 to prevent reverse flow of the current transmitted therethrough.

In a preferred embodiment, the current directors 212,214 are diodes that are capable of directing a selected portion of the waveform of the source current. For example, where the source current is alternating current having a traditional sinusoidal waveform or another suitable waveform, the first current directors 212 can conduct a first portion of the waveform through the first welding elements 102 and the second current directors 214 can conduct a second portion of the waveform through the second welding elements 104, such that the first and second portions of the waveform are cyclically directed through the first and second welding elements 102,104. In a further embodiment, the current directors 212,214 can be configured to direct the current through a first portion of the circuit during a first portion, e.g., a positive portion, of the waveform to direct the current through the first welding elements 102 and to direct the current through a second portion of the circuit during a second portion, e.g., a negative portion, of the waveform to direct the current through the second welding elements 104.

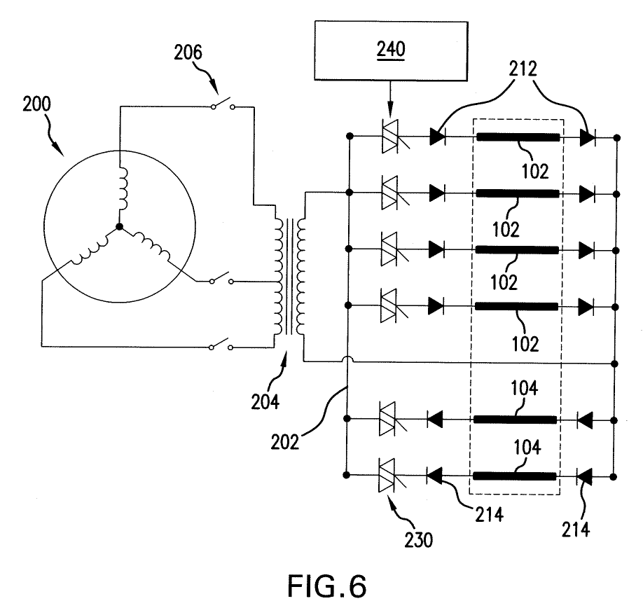

Referring to the embodiment shown in FIGS. 4 and 5A-5B, the power source 200 supplies an AC source current having a traditional sinusoidal waveform 220 shown in FIG. 5A. The source current is supplied through the current line 201 and neutral line 203. The first current directors 212 can be diodes configured to direct a positive portion 222 of the waveform 220 through the first welding elements 102, and the second current directors 214 can be diodes configured to direct a negative portion 224 of the waveform 220 through the second welding elements 104. The current transmitted through the welding elements 102,104 flows primarily in the direction directed by the current directors 212,214, with little or no current flow or leakage in another direction. Consequently, the first welding elements 102 receive primarily the positive waveform portion 222, while the second welding elements 104 receive primarily the negative waveform portion 224, such that the positive and negative portions 222,224 of the waveform 220 are cyclically directed through the first and second welding elements 102,104. Because different portions 222,224 of the sinusoidal waveform 220, which are phase-shifted by 180°, are conducted to alternatingly power the welding elements 102,104, there is no short circuiting around the welding elements 102,104 intended to be heated. Thus, no electrical insulation is needed between the electrically contacting welding elements 102,104.

Further advantageously, welds formed without insulation according to the invention have been found by the inventors to be generally more uniform and even compared to welds formed by conventional processes using insulation material between intersecting welding elements, which usually causes weld protrusions at the intersections of welding element intersections and uneven welds due to the slimming of the insulating material. Also, because the entire current travels through each welding element 102,104 in the selected fraction of the waveform cycle, such as each half cycle, it has been found that there is no significant increase in welding time, which remains substantially the same as conventional pulse heat welding that does not use any current director. For example, the welding time is about 2 seconds for welding a polypropylene film of about 100 μm along two directions of weld lines.

In preferred embodiments, a power factor controller 230 can be connected between the power source 200 and the heating elements 102,104, for controlling the power factor, i.e., the voltage magnitude, of the current transmitted to the heating elements 102,104. For example, the power factor controller 230 can be configured to conduct the current by the full power factor, i.e., 100% of the current voltage, or by a reduced power factor, i.e., less than 100% of the current voltage. The power factor controller 230 is preferably configured to apply a preselected power factor to the current transmitted therethrough. Any suitable and desired power factor can be selected. In an embodiment, the power factor controller 230 is configured to conduct about 5% to 90% of the current voltage, preferably about 10% to 80%, and more preferably about 15% to 60%, but other percentages can be used in other embodiments.

The power factor controller 230 can comprise a phase controller that is capable of selectively conducting a fraction of the current waveform portions conducted therethrough. The phase controller 230 is preferably configured to conduct a preselected fraction of the current waveform portions conducted therethrough. Any suitable and desired fraction can be selected. Preferably, the phase controller 230 is a triode (also known as TRIAC, meaning triode for alternating current) or two silicon controlled rectifiers (SCR) that are joined together in an inverse parallel configuration, but any other suitable device capable of selectively conducting a fraction of the current waveform portions can be used.

Preferably, a power factor controller 230 is connected between the power source 200 and each welding element 102,104 as shown in FIGS. 3-4 and 6-7. The power factor controller 230 can be connected directly between the power source 200 and the welding elements 102,104 as shown in FIG. 4, or can be connected therebetween through other circuit elements, such as transformers 204 or on-off switches 208, as shown in FIGS. 3, 6, and 7. A person having ordinary skill in the art would appreciate how to design a circuit that provides a desired current power factor to the welding elements 102,104.

In the embodiment shown in FIGS. 4 and 5A-5D, the power source 200 can provide an AC source current having the traditional sinusoidal waveform 220, and the current directors 212,214 can be configured to selectively conduct positive and negative portions 222,224, respectively, of the source current waveform, as described above. Phase controllers 230 are provided between the power source 200 and current directors 212,214 to control the power factor/phase of the current conducted to the current directors 212,214. The phase controllers 230 can be configured to conduct the source current in full phases, such that the voltage of the source current is unchanged. Alternatively, the phase controllers 230 can be configured to selectively conduct a fraction 226 of the current waveform conducted therethrough, such that the positive and negative portions 228,230 of this waveform fraction 226 are conducted to the welding elements 102,104 through the current directors 212,214.

Advantageously, the power factor controller 230 does not require a complex system setup and does not cause power dissipation. Thus, the power factor controller 230 achieves the desired voltage with ease and high power efficiency. The power factor controller 230 also allows welding by firing the electrical power in one-time firing, wherein welding is achieved by turning on the power source 200 for a short period of time. For example, for welding polypropylene sheets, for example to make a conventional polypropylene ring binder, the power source 200 is turned on for less than 2 seconds, more preferably less than 1 second.

Preferably, the power factor controllers 230 are connected to an electronic regulator 240. The electronic regulator 240 is configured to regulate the timing and power factor of the current transmitted through the power factor controller 230. The electronic regulator 240 controls the welding time and power factor by controlling the operative parameters of the power factor controller 230. The electronic regulator 240 is preferably a microprocessor controller that is capable of regulating the timing within the step of 0.05 seconds, and more preferably within the step of 0.01 second. In preferred embodiments, the electronic regulator 240 is set to provide the current to the power factor controller 230 in pulses of about 0.2 to 6 seconds, preferably about 0.3 to 4 seconds, and more preferably about 0.5 to 2 seconds, with rest periods of about 0.1 seconds between pulses.

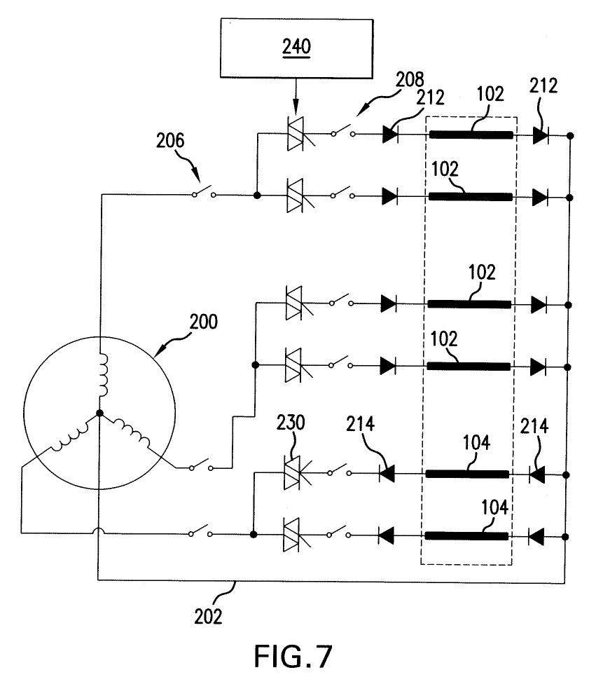

Other suitable and desired circuit components and devices can be included in the pulse heat welding circuit according to the invention. For example, the circuit embodiment shown in FIG. 6 additionally includes a transformer 204 between the power source 200 and power factor controllers 230 and on-off switches 206. The switches 206 can be mechanical on-off switches, e.g., 3-phase mechanical on-off switches, or relay contacts, such as normally open relay contacts, e.g., 3-phase circuit breaker relay. The switches 206 can be operably connected to a microprocessor controller, e.g., placed within the microprocessor controller or configured to receive the current output from the microprocessor controller. The switches 206 are preferably controlled to be turned on and off during each pulse heat welding cycle, before and after the current is transmitted to the power factor controller 230. The circuit embodiment shown in FIG. 7 also includes switches 206, and also includes on-off mechanical contact switches 208 between each power factor controller 230 and current director 212,214, for further controlling the current flow to the welding elements 102,104. For example, the switches 208 can be turned on when the welding member 30 and pressure member 40 are operably engaged with each other and turned off after welding operation.

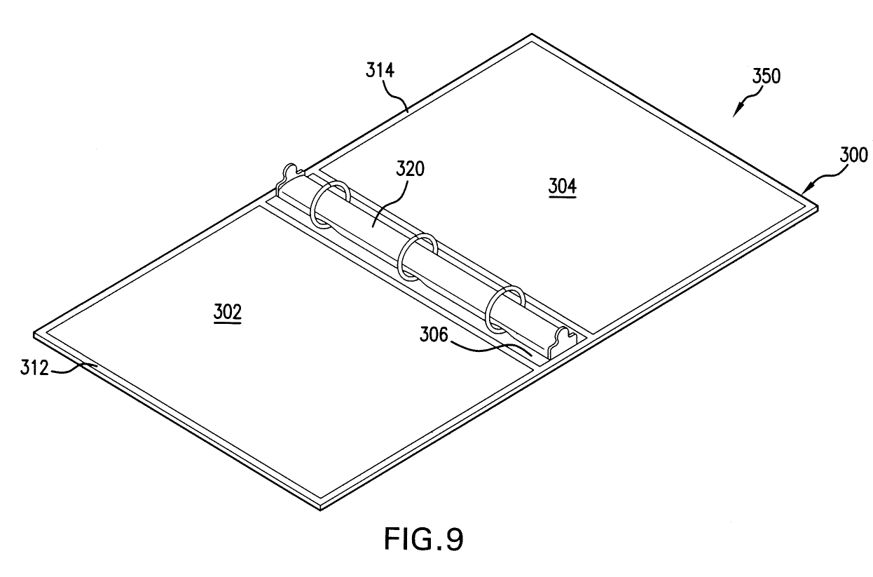

The present electrical welding process and device can be used with any suitable electrical welding process. In an embodiment, the electrical welding is pulse heat welding, in which electrical energy is conducted to the welding elements 102,104 in pulses. The present welding process and device also can be used to weld any suitable type of workpiece materials. One suitable type of material is plastic, including thermoplastic. In an embodiment, the workpieces are thermoplastic binder covers, such as polypropylene binder covers. An example of a thermoplastic binder cover 300 and a finished 3-ring binder 350 made therefrom are shown in FIGS. 8 and 9. The binder cover 300 has first and second side panels 302,304 and a middle panel 306 therebetween. The binder cover material is welded along the outer edges thereof with continuously extending vertical and horizontal weld seams 312,314. Additional vertical inner weld seams 312 extend transversely across the horizontal weld seams 314. These weld seams define the panels 302,304,306 and predetermined bending points of the binder cover 300. To make a ring binder 350, a ring binding member 320, such as snap rings or the like, is attached to the panel 306.

As used herein, the term “about” should generally be understood to refer to both the corresponding number and a range of numbers. In addition, all numerical ranges herein should be understood to include each whole integer within the range. While illustrative embodiments of the invention are disclosed herein, it will be appreciated that numerous modifications and other embodiments may be devised by those skilled in the art. For example, the features for the various embodiments can be used in other embodiments. Therefore, it will be understood that the appended claims are intended to cover all such modifications and embodiments that come within the spirit and scope of the present invention.

What is claimed is:

1. A method for electrically welding two workpieces, comprising:
placing a first and second welding elements in association with first and second portions of the workpieces, respectively, for heating and welding the workpieces; and
powering the first and second welding elements out of phase from a common power source.

2. The method of claim 1, further comprising:
alternatingly directing a current through each of the first and second welding elements for causing the first and second welding elements to weld the workpieces substantially simultaneously.

3. The method of claim 2, wherein the welding elements comprise heating elements, and the current is directed therethrough for pulse welding the first and second portions of the workpieces.

4. The method of claim 3, wherein the heating elements are metal wires or coils.

5. The method of claim 2, wherein:
the first and second welding elements are electrically connected; and
the current is alternatingly directed through the first and second welding elements by applying a potential difference alternatingly across:
ends of the first welding element, and
ends of the second welding element.

6. The method of claim 2, wherein the workpieces are made of a thermoplastic material.

7. The method of claim 6, wherein the thermoplastic material is polypropylene.

8. The method of claim 2, further comprising:
providing from the power source a source current that has a waveform; and
cyclically directing a first portion of said waveform through the first welding element and a second portion of said waveform through the second welding element.

9. The method of claim 8, wherein the source current is an alternating current, wherein a positive portion of the waveform is directed through the first welding element, and a negative portion of the waveform is directed through the second heating element.

10. The method of claim 9, further comprising providing a current director in a circuit with the welding elements, which current director is configured to direct the current through a first portion of the circuit during the positive portion of the waveform to direct the current through the first welding element and to direct the current through a second portion of the circuit during the negative portion of the waveform to direct the current through the second welding element.

11. The method of claim 10, wherein the current director comprises diodes arranged to direct each of the waveform portions respectively through the first and second welding elements.

12. The method of claim 10, further comprising controlling a power factor of the waveform that is directed through the welding elements with a power factor controller that is connected between the power source and the current director.

13. The method of claim 12, wherein the power factor controller comprises a phase controller configured for conducting a fraction of the waveform portions.

14. The method of claim 13, wherein:
the first welding element comprises a plurality of first welding elements;
the second welding element comprises a plurality of second welding elements connected in parallel with each other;
the current director comprises a current director associated with each of the first and second welding elements; and
the power factor controller comprises a phase controller connected between the power source and each current director.

15. The method of claim 13, wherein the phase controller comprises a triode or two silicon-controlled rectifiers joined in an inverse parallel configuration.

16. The method of claim 2, wherein the first welding element comprises a plurality of welding elements connected in parallel with each other, and the second welding element comprises a plurality of second welding elements connected in parallel with each other.

17. The method of claim 16, wherein the one of the first and second welding elements are arranged to weld horizontal lines in the workpieces, and the other of the first and second welding elements are arranged to weld vertical lines in the workpieces.

18. The method of claim 17, wherein the workpieces are thermoplastic sheets, the method further comprising placing a plurality of inserts between the sheets surrounded by the first and second portions of the workpieces to provide a folder cover.

19. The method of claim 18, further comprising attaching a paper binding mechanism to the folder cover to provide a binder.

20. An electrical welder for welding two workpieces, comprising:
first and second welding elements configured to associate with first and second portions of the workpieces, respectively, for heating and welding the workpieces;
a power source connected to the first and second welding elements; and
an electrical circuit configured to conduct a current out of phase from the power source to the first and second welding elements.

21. The welder of claim 20, further comprising a current director configured to alternatingly direct a current through each of the first and second welding elements for causing the first and second welding elements to weld the workpieces substantially simultaneously.

22. The welder of claim 21, wherein the welding elements comprise heating elements that are electrically connected and the current director is configured to alternatingly direct the current through the heating elements for pulse welding the first and second portions of the workpieces.

23. The welder of claim 21, wherein the power source supplies to the circuit an alternating current having a waveform and the current director comprises diodes configured to direct the current through a first portion of the circuit during the positive portion of the waveform to direct the current through the first welding element and to direct the current through a second portion of the circuit during the negative portion of the waveform to direct the current through the second welding element.

24. The welder of claim 21, further comprising a power factor controller that is connected between the power source and the current director, wherein the power supply supplies to the circuit an alternating current having a waveform and the power factor is configured to control a power factor of the waveform that is directed through the welding elements.

25. The welder of claim 24, wherein the power factor controller comprises a triode or two silicon-controlled rectifiers joined in an inverse parallel configuration that are configured for conducting a fraction of the waveform portions.
